(19) United States
(12) Patent Application Publication
(10) Pub. No.: US 2020/0030939 A1
(43) Pub. Date: Jan. 30, 2020

(54) ESTIMATION MODEL CREATING DEVICE FOR GRINDING WHEEL SURFACE CONDITION ESTIMATION, GRINDING WHEEL SURFACE CONDITION ESTIMATING DEVICE, ADJUSTMENT MODEL CREATING DEVICE FOR GRINDING MACHINE OPERATION COMMAND DATA ADJUSTMENT, AND UPDATING DEVICE FOR GRINDING MACHINE OPERATION COMMAND DATA UPDATE

(71) Applicant: JTEKT Corporation, Osaka-shi (JP)

(72) Inventors: Yuki MASUDA, Nagoya-shi (JP); Toru KAWAHARA, Chita-gun (JP); Shinji MURAKAMI, Toyota-shi (JP)

(73) Assignee: JTEKT Corporation, Osaka-shi (JP)

(21) Appl. No.: 16/520,702

(22) Filed: Jul. 24, 2019

(30) Foreign Application Priority Data
Jul. 25, 2018 (JP) 2018-139212

(51) Int. Cl. B24B 53/00; G06N 20/00

(52) U.S. Cl. CPC B24B 53/00; B24B 49/003; G06N 20/00

(57) ABSTRACT

An estimation model creating device for grinding wheel surface condition estimation includes a measurement data obtaining unit and a first learning model creating unit. The measurement data obtaining unit obtains measurement data measured during grinding of workpieces with a grinding wheel in a grinding machine. The measurement data obtaining unit obtains the measurement data for a predetermined period of time for each workpiece. The measurement data includes at least one of first measurement data indicating the condition of a structural member of the grinding machine, and second measurement data relating to a ground portion of the workpiece. The first learning model creating unit performs machine learning using the measurement data relating to the workpieces as first-learning input data so as to create a first learning model for estimating a surface condition of the grinding wheel.

### INCORPORATION BY REFERENCE

The disclosure of Japanese Patent Application No. 2018-139212 filed on Jul. 25, 2018 including the specification, drawings and abstract, is incorporated herein by reference in its entirety.

### BACKGROUND OF THE INVENTION

### 1. Field of the Invention

The invention relates to an estimation model creating device for grinding wheel surface condition estimation, a grinding wheel surface condition estimating device, an adjustment model creating device for grinding machine operation command data adjustment, and an updating device for grinding machine operation command data update.

### 2. Description of Related Art

When a grinding machine is used to grind a workpiece with a grinding wheel, truing and dressing of the surface of the grinding wheel need to be performed in order to maintain the sharpness of the grinding wheel. A drop in the sharpness of a grinding wheel may cause a drop in the quality of a ground workpiece. For this reason, truing and dressing of a grinding wheel are performed each time a predetermined number of workpieces are ground, and the predetermined number is determined in such a manner as not to cause a drop in the quality of the ground workpieces. However, since a grinding machine operator determines the predetermined number, there is a risk that grinding may be continued even after the sharpness drops. In such a case, the quality of the ground workpieces may drop.

In this regard, Japanese Patent Application Publication No. 2002-307304 (JP 2002-307304 A) discloses that a vibration detector is mounted on a spindle head to detect vibrations of the spindle head and that when the vibration amplitude of the spindle head reaches a value that is preset according to grinding accuracy required for the ground surface of a workpiece, the grinding process is stopped, and dressing of a grinding wheel is performed.

These days, with improvements in computer processing speed, artificial intelligence is developing rapidly. For example, Japanese Patent Application Publication No. 2017-164801 (JP 2017-1648014 A) discloses that machine learning is used to create laser machining condition data.

A concern with the approach disclosed in JP 2002-307304 A is that it is difficult to accurately check the sharpness of the grinding wheel by simply determining whether the vibration of the spindle head reaches the preset value. This makes it difficult to determine the proper timing of correction (i.e., truing and dressing) of the grinding wheel. Thus, to determine the surface condition of a grinding wheel, only the instantaneous vibration information is insufficient, and more information is needed.

### SUMMARY OF THE INVENTION

A purpose of the invention is to provide a device for creating a model for estimating a surface condition of a grinding wheel and to provide a device for estimating the surface condition using the model.

A first aspect of the invention provides an estimation model creating device for grinding wheel surface condition estimation including a measurement data obtaining unit and a first learning model creating unit. The measurement data obtaining unit is configured to obtain measurement data pieces acquired by measurement during grinding of workpieces with a grinding wheel in a grinding machine. Each measurement data piece is obtained for a predetermined period of time during grinding of a corresponding workpiece. Each measurement data piece includes at least one of first measurement data and second measurement data. The first measurement data indicates a condition of a structural member of the grinding machine. The second measurement data relates to a ground portion of the corresponding workpiece. The first learning model creating unit performs machine learning using the measurement data relating to the workpieces as first-learning input data so as to create a first learning model for estimating a surface condition of the grinding wheel.

According to the first aspect, the first learning model is created by machine learning that uses the measurement data pieces as the first-learning input data. Each measurement data piece includes at least one of the first measurement data indicating the condition of the structural member of the grinding machine, and the second measurement data related to the ground portion of the corresponding workpiece. Each measurement data piece is obtained for a predetermined period of time during grinding of the corresponding workpiece. For example, the predetermined period may be from the start to the end of the process of grinding the corresponding workpiece or from the start to the end of one stage of the grinding process, such as a rough grinding stage. As a result, the amount of each measurement data piece becomes large. Therefore, the total amount of all the measurement data pieces of multiple workpieces becomes extremely large. However, the use of machine learning makes it easy to create the first learning model using the extremely large amount of the measurement data in connection with grinding of the multiple workpieces.

In this way, the first learning model is created by taking into account the extremely large amount of the measurement data that influences the surface condition of the grinding wheel. This enables the first learning model to estimate the surface condition of the grinding wheel. Examples of the first measurement data indicating the condition of the structural member of the grinding machine may include vibration of the structural member and the amount of deformation of the structural member. Examples of the second measurement data relating to the ground portion may include the size of the workpiece that changes as the workpiece is ground, and a temperature at a point of contact between the grinding wheel and the workpiece.

A second aspect of the invention provides a grinding wheel surface condition estimating device including the estimation model creating device for grinding wheel surface condition estimation according to the first aspect, and a surface condition estimating unit. The surface condition estimating unit estimates the surface condition of the grinding wheel after a new workpiece is ground, by using the first learning model and estimation input data. The estimation input data has the same type of data as each measurement data piece and is obtained for a predetermined period of time during grinding of the new workpiece. The use of the first learning model created by the machine learning enables the surface condition of the grinding wheel after the new workpiece is grounded to be estimated on the basis of the estimation input data as large measurement data measured during grinding of the new workpiece.

A third aspect of the invention provides an adjustment model creating device for grinding machine operation command data adjustment including an operation command data obtaining unit, a surface condition data obtaining unit, a reward determining unit, and a second learning model creating unit. The operation command data obtaining unit obtains operation command data pieces in connection with grinding of workpieces with a grinding wheel in a grinding machine. Each operation command data piece is used to control a controller of the grinding machine during grinding of a corresponding workpiece. The surface condition data obtaining unit obtains surface condition data pieces about a surface condition of the grinding wheel. Each surface condition data piece is obtained in connection with grinding of a corresponding workpiece. The reward determining unit determines a reward for each operation command data piece in accordance with a corresponding surface condition data piece. Each surface condition data piece is obtained in connection with grinding of a corresponding workpiece. The second learning model creating unit performs machine learning using each operation command data piece and the reward relating to multiple workpieces to create a second learning model for adjusting each operation command data piece in such a manner as to increase the reward.

According to the third aspect, the adjustment model creating device performs the machine learning to create the second learning model for adjusting the operation command data for the grinding machine. The machine learning uses the operation command data and the rewards relating to multiple workpieces. Thus, although a large amount of data is used to create the second learning model, the use of the machine learning facilitates creation of the second learning model. Further, the machine learning adjusts the operation command data for the grinding machine in such a manner as to increase the reward that is determined on the basis of the surface condition data after the workpiece is ground. Thus, the operation command data is created in accordance with the surface condition of the grinding wheel.

A fourth aspect of the invention provides an updating device for grinding machine operation command data update including the adjustment model creating device according to the third aspect and an operation command data adjusting unit. The operation command data adjusting unit adjusts the operation command data piece for a first new workpiece to be ground after a second new workpiece, by using the operation command data piece for the second new workpiece, the surface condition data piece relating to the second new workpiece, the reward, and the second learning model. According to the fourth aspect, the operation command data is updated using the second learning model created by the machine learning. Thus, when grinding conditions change, the operation command data is updated in accordance with the present grinding condition. This update of the operation command data allows grinding to be performed in accordance with the surface condition of the grinding wheel.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a plan view of a grinding machine;

FIG. 2 is a functional block diagram illustrating the general structure of a machine learning device according to a first embodiment;

FIG. 3 is a functional block diagram illustrating the detailed structure of a learning phase of the machine learning device according to the first embodiment;

FIG. 4 is a functional block diagram illustrating the detailed structure of an estimation phase of the machine learning device according to the first embodiment;

FIG. 5 is a functional block diagram illustrating the general structure of a machine learning device according to a second embodiment;

FIG. 6 is a functional block diagram illustrating the detailed structure of a learning phase of the machine learning device according to the second embodiment; and

FIG. 7 is a functional block diagram illustrating the detailed structure of an estimation phase of the machine learning device according to the second embodiment.

### DETAILED DESCRIPTION OF EMBODIMENTS

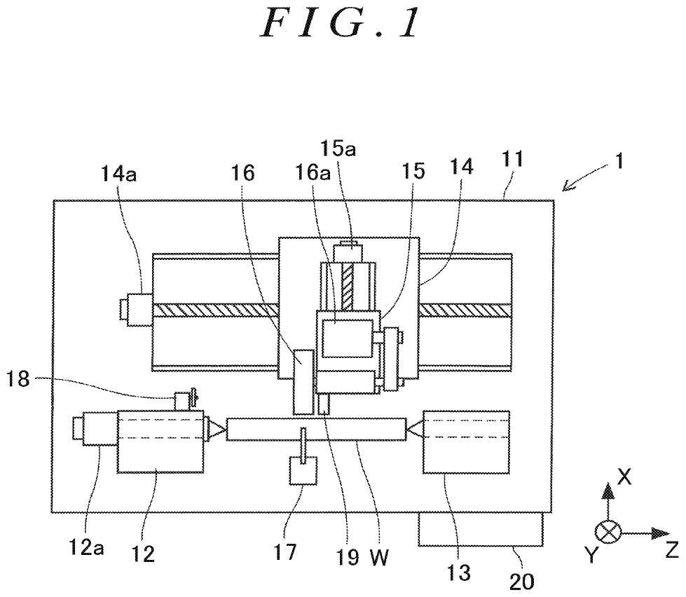

The structure of a grinding machine 1 is described with reference to FIG. 1. The grinding machine 1 is used to grind a workpiece W. The grinding machine 1 is any type of grinding machine, including an external cylindrical grinding machine and a cam grinding machine. According to the first embodiment, the grinding machine 1 is an external cylindrical grinding machine of a wheel head traverse type. Alternatively, the grinding machine 1 may be of a table traverse type.

The grinding machine 1 mainly includes a bed 11, a headstock 12, a tailstock 13, a traverse base 14, a wheel spindle stock 15, a grinding wheel 16, a sizing device 17, a grinding wheel correction device 18, a coolant device 19, and a controller 20.

The bed 11 is fixed on an installation surface. The headstock 12 is mounted on the top surface of the bed 11. The headstock 12 is located closer to a front side of the bed 11 in an X-axis direction (i.e., bottom side in FIG. 1) and is located closer to one side of the bed 11 in a Z-axis direction (i.e., left side in FIG. 1). The headstock 12 supports the workpiece W such that the workpiece W is rotatable about the Z-axis. The workpiece W is rotated by driving of a motor 12a that is mounted to the headstock 12. The tailstock 13 is mounted on the top surface of the bed 11 and faces the headstock 12 in the Z-axis direction. That is, the tailstock 13 is located closer to the front side of the bed 11 in the X-axis direction and located closer to the other side of the bed 11 in the Z-axis direction (i.e., right side in FIG. 1). Thus, the workpiece W is rotatably supported at both ends by the headstock 12 and the tailstock 13.

The traverse base 14 is mounted on the top surface of the bed 11 and is movable in the Z-axis direction. The traverse base 14 is hereinafter sometimes referred to as a movable member 14. The traverse base 14 is moved by driving of a motor 14a that is mounted to the bed 11. The wheel spindle stock 15 is mounted on the top surface of the traverse base 14 and is movable in the X-axis direction. The wheel spindle stock 15 is hereinafter sometimes referred to as a movable member 15. The wheel spindle stock 15 is moved by driving of a motor 15a that is mounted to the traverse base 14. The grinding wheel 16 is rotatably supported by the wheel spindle stock 15. The grinding wheel 16 is rotated by driving of a motor 16a that is mounted to the wheel spindle stock 15. The grinding wheel 16 has abrasive grains held together by a bonding material.

The sizing device 17 measures the size (e.g., the diameter) of the workpiece W. The grinding wheel correction device 18 corrects the shape of the grinding wheel 16. The grinding wheel correction device 18 performs truing of the grinding wheel 16. The grinding wheel correction device 18 may perform dressing of the grinding wheel 16 in addition to or instead of the truing. The grinding wheel correction device 18 also has a function to measure the size (e.g., the diameter) of the grinding wheel 16.

The truing is the process of correcting the shape of the grinding wheel 16 and includes, for example, the following: when the grinding wheel 16 wears through use, shaping the grinding wheel 16 in accordance with the shape of the workpiece W; and removing runout of the grinding wheel 16 due to irregular wear. The dressing is the process of dressing (sharpening) the grinding wheel 16 and includes, for example, the following: adjusting the protrusion height of abrasive grains in the grinding wheel 16; regenerating cutting edges of the abrasive grains; and remedying glazing, loading, and shedding. In normal cases, the dressing is performed after the truing.

The coolant device 19 supplies a coolant to a point of contact between the grinding wheel 16 and the workpiece W. The coolant device 19 collects the coolant, cools the collected coolant to a predetermined temperature, and resupplies the cooled coolant to the point of contact between the grinding wheel 16 and the workpiece W.

The controller 20 controls driving devices on the basis of a numerical control (NC) program that is created on the basis of operation command data including information about the shape of the workpiece W, machining conditions, the shape of the grinding wheel 16, the timing of when to supply the coolant, etc. Specifically, the controller 20 receives the operation command data as input, creates the NC program on the basis of the operation command data, and controls the motors 12a, 14a, 15a, and 16a and the coolant device 19 on the basis of the NC program, thereby performing grinding of the workpiece W. The controller 20 continues to grind the workpiece W until the workpiece W is ground to a predetermined finished shape, on the basis of the diameter of the workpiece W measured by the sizing device 17. Further, at the timing of when to correct the grinding wheel 16, the controller 20 corrects the grinding wheel 16 (i.e., performs truing and dressing) by controlling the motors 14a, 15a, and 16a, the grinding wheel correction device 18, etc.

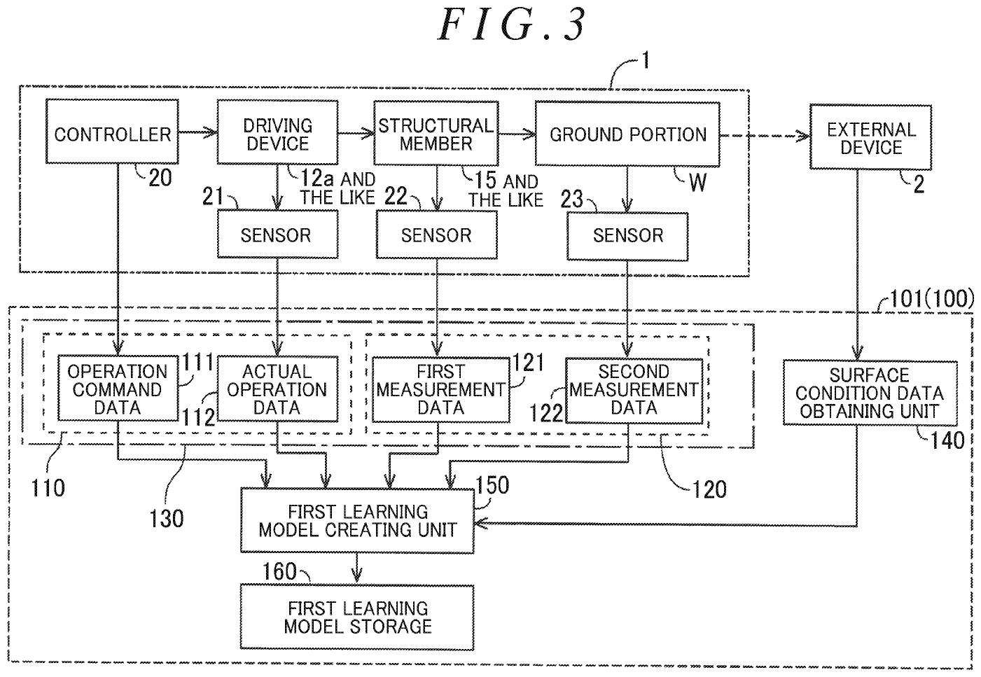

Although not illustrated in FIG. 1, the grinding machine 1 includes various types of sensors 21, 22, and 23 (refer to, for example, FIG. 3) described later. For example, the grinding machine 1 may include the following sensors: a sensor for detecting actual operation data on actual operation of each motor; a sensor for detecting conditions of structural members that structure the grinding machine 1; the sizing device 17; a sensor for detecting the diameter of the grinding wheel 16; and a temperature sensor. Details of the sensors are described later.

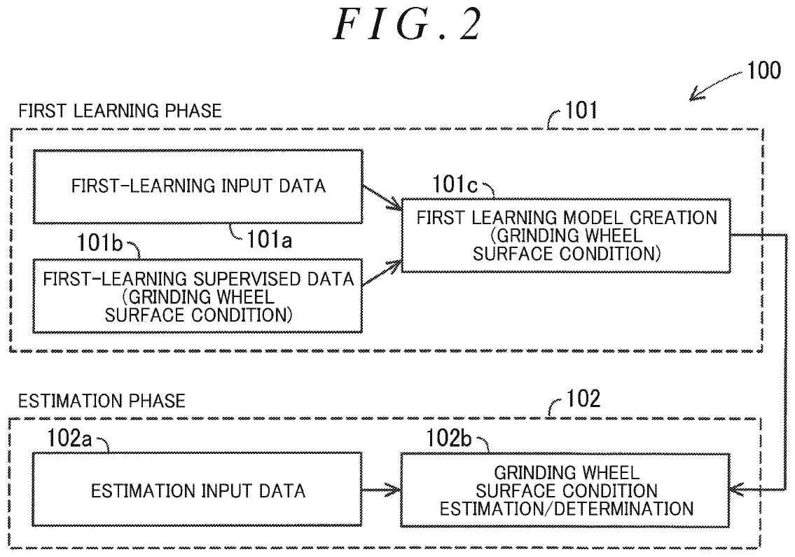

Next, the general structure of a machine learning device 100 according to the first embodiment is described with reference to FIG. 2. The machine learning device 100 performs the following: (a) creates a first learning model for estimating the surface condition of the grinding wheel 16; and (b) estimates the surface condition of the grinding wheel 16 using the first learning model. The machine learning device 100 may be either separate from the grinding machine 1 or integrated into the grinding machine 1, for example, into the controller 20. According to the first embodiment, the machine learning device 100 is connected to the grinding machine 1 via a network line and exchanges various types of data with the grinding machine 1.

The machine learning device 100 includes elements 101a, 101b, and 101c, and elements 102a and 102b. The elements 101a, 101b, and 101c function in a first learning phase 101 that creates the first learning model. The elements 102a and 102b function in an estimation phase 102 (typically called an inference phase) that estimates the surface condition of the grinding wheel 16. Specifically, in the first learning phase 101, the element 101a obtains first-learning input data, the element 101b obtains first-learning supervised data, and the element 101c creates the first learning model.

The first-learning input data obtained by the element 101a is input data to be used in machine learning. For example, the first-learning input data includes the operation command data, the actual operation data, first measurement data (data indicating conditions of structural members), and second measurement data (data relating to a ground portion of the workpiece W being ground).

The first-learning supervised data obtained by the element 101b is supervised data to be used for supervised learning in the machine learning. The first-learning supervised data is data indicating the surface condition of the grinding wheel 16 (hereinafter referred to as “surface condition data of the grinding wheel 16”). Examples of the surface condition data of the grinding wheel 16 may include data relating to occurrence of glazing, loading, or shedding of the grinding wheel 16 and data relating to occurrence of excessive sharpening of the grinding wheel 16.

The surface of the grinding wheel 16 influences the quality of the workpiece W that is ground. That is, the surface condition of the grinding wheel 16 indicates the degree of influence on the quality of the workpiece W that is ground. Examples of the surface condition of the grinding wheel 16 may include the following conditions: glazing, loading, or shedding occurs on the surface of the grinding wheel 16; and the surface of the grinding wheel 16 is excessively sharpened. If the surface condition of the grinding wheel 16 is not good, the quality of the workpiece W that is ground with the grinding wheel 16 may be degraded. For this reason, it is necessary to grasp the surface condition of the grinding wheel 16.

If glazing, loading, or shedding occurs on the surface of the grinding wheel 16, it is necessary to perform the dressing process or to perform the truing process for reshaping before the dressing process. If the surface of the grinding wheel 16 is excessively sharpened, it is necessary to perform the truing process. In normal cases, the truing process is followed by the dressing process. The grinding wheel 16 needs to be replaced with a new one when the truing process is performed a predetermined number of times or when the truing process removes a predetermined amount from the grinding wheel 16 to reshape the grinding wheel 16.

To increase the life of the grinding wheel 16, it is necessary to reduce the number of times the truing and dressing processes are performed. Further, the time taken to perform the truing and dressing processes and the time taken to replace the grinding wheel 16 increase a grinding cycle time. It is commonly required to reduce the grinding cycle time. From this point of view, it is also necessary to grasp the surface condition of the grinding wheel 16. For this reason, the element 101b obtains the surface condition data of the grinding wheel 16 as the first-learning supervised data. The surface condition data of the grinding wheel 16 is data indicating the degree of influence on the quality of the workpiece W that is ground.

The element 101c creates the first learning model by the supervised learning in the machine learning on the basis of the first-learning input data and the first-learning supervised data. The first learning model is a model (a function) used to estimate the surface condition of the grinding wheel 16. Alternatively, the first learning model may be created by unsupervised learning so that the first learning model can be used to classify the surface condition of the grinding wheel 16. However, creating the first learning model by the supervised learning makes it possible to estimate the surface condition of the grinding wheel 16 with high accuracy.

Next, the elements 102a and 102b of the machine learning device 100 are described. As already described, the elements 102a and 102b function in the estimation phase 102 that estimates the surface condition of the grinding wheel 16. The element 102a obtains estimation input data. The estimation input data obtained by the element 102a has the same type of data as the first-learning input data and is obtained in connection with grinding of a workpiece W (a new workpiece W) other than the workpieces W used to create the first learning model.

On the other hand, the element 102b estimates the surface condition of the grinding wheel 16 and determines whether to perform the following processes: truing of the grinding wheel 16; dressing of the grinding wheel 16; and replacement of the grinding wheel 16. The element 102b estimates the surface condition of the grinding wheel 16 using the estimation input data and the first learning model, and then determines whether to perform the above processes, such as truing of the grinding wheel 16, on the basis of the estimated surface condition. The first learning model to be used by the element 102b is created by the machine learning in the first learning phase 101.

The structure of the grinding machine 1 in relation to the machine learning device 100 is described with reference to FIG. 3. As illustrated in FIG. 3, the grinding machine 1 includes the controller 20. The controller 20 is what is called a computerized numerical control (CNC) controller. As already described, the controller 20 creates an NC program on the basis of the operation command data, and controls the driving devices 12a, 14a, 15a, 16a, 17, and 18 (in FIG. 3, collectively denoted as “12a and the like”) on the basis of the NC program.

The structural members 12, 13, 14, and 15 (in FIG. 3, collectively denoted as “15 and the like”) are operated by driving of the driving devices 12a, 14a, 15a, 16a, 17, and 18. The operations of the structural members 12, 13, 14, and 15 cause the grinding wheel 16 to grind the workpiece W. A “ground portion” in FIG. 3 refers to a portion of the workpiece W being ground with the grinding wheel 16.

The grinding machine 1 further includes the following sensors: the sensor 21 for detecting actual operation data on actual operation of the driving devices 12a, 14a, 15a, 16a, 17, and 18; the sensor 22 for detecting conditions of the structural members 12, 13, 14, and 15 (i.e., for detecting data indicating conditions of the structural members); and the sensor 23 for detecting data (ground portion data) on the ground portion of the workpiece W that changes in shape as the workpiece W is ground. The sensor 21 includes, for example, a current sensor for detecting driving current to the motor 12a and a position sensor for detecting a present position (a rotation angle) of the motor 12a. For the other driving devices 14a, 15a, 16a, 17 and 18, the sensor 21 detects the same type of information as described above for the motor 12a. The sensor 22 includes, for example, a vibration sensor for detecting vibrations of the structural members 12, 13, 14, and 15 and a strain-gauge sensor for detecting the amount of deformation of the structural members 12, 13, 14, and 15. Examples of the vibration sensor includes a sensor for detecting acceleration due to the vibrations and a sensor for detecting sound waves due to the vibrations. The sensor 23 includes, for example, a sizing device for detecting the size (the diameter) of the workpiece W that changes as the workpiece W is ground, and a temperature sensor for detecting a temperature at the point of contact between the grinding wheel 16 and the workpiece W being ground with the grinding wheel 16.

The structure of an external device 2 in relation to the machine learning device 100 is described with reference to FIG. 3. During grinding of workpieces W with the grinding wheel 16 in the grinding machine 1, the external device 2 detects data correlating to the surface condition data of the grinding wheel 16 for each of the workpieces W. The surface condition data of the grinding wheel 16 is data indicating the degree of influence on the quality of the workpiece W that is ground. That is, data on the quality of the ground workpiece W is used as the data correlating to the surface condition data of the grinding wheel 16. Specifically, the surface condition data of the grinding wheel 16 includes the following, as the data indicating the degree of influence on the quality of the workpiece W that is ground: first surface condition data corresponds to the condition of a damaged layer of the workpiece W (e.g., data about grinding burn); second surface condition data corresponds to surface texture of the workpiece W (e.g., data about surface roughness); and third surface condition data corresponds to the condition of a chatter pattern on the workpiece W.

That is, the external device 2 includes the following: a damaged layer detector for obtaining damaged layer data (e.g., data about grinding burn, data about a softened layer caused by grinding, etc.); a surface texture meter for obtaining surface texture data (e.g., data about surface roughness); and a chatter detector or obtaining chatter pattern data. The external device 2 may directly obtain the damaged layer data, the surface texture data, and the chatter pattern data. Alternatively, the external device 2 may indirectly obtain the damaged layer data, the surface texture data, and the chatter pattern data as follows: first obtains other data correlating to the damaged layer data, the surface texture data, and the chatter pattern data; and then obtains the damaged layer data, the surface texture data, and the chatter pattern data by calculation using the other data.

The damaged layer data may indicate whether the ground workpiece W has a damaged layer. Alternatively, the damaged layer data may be a score indicating the degree of the damaged layer. The surface texture data may be an exact value of surface roughness of the ground workpiece W. Alternatively, the surface texture data may be a score indicating the degree of the surface roughness. The chatter pattern data may indicate whether the ground workpiece W has a chatter pattern. Alternatively, the chatter pattern data may be a score indicating the degree of the chatter pattern. For example, each score may be expressed in grades.

The detailed structure of the first learning phase 101 of the machine learning device 100 is described with reference to FIG. 3. The structure of the first learning phase 101 corresponds to an estimation model creating device for grinding wheel surface condition estimation.

The structure of the first learning phase 101 includes the following: a first input data obtaining unit 130 for obtaining first input data; a surface condition data obtaining unit 140 for obtaining the surface condition data of the grinding wheel 16; a first learning model creating unit 150; and a first learning model storage 160.

The first input data obtaining unit 130 obtains, as the first-learning input data for the machine learning, the first input data relating to multiple workpieces W. Each time grinding of one of the workpieces W is finished, the surface condition data obtaining unit 140 obtains, as the first-learning supervised data for the machine learning, the surface condition data of the grinding wheel 16 relating to the ground workpiece W. Examples of the first-learning input data and the first-learning supervised data are shown in Table 1. Although Table 1 shows that the first-learning input data includes various data items, the first-learning input data does not necessarily include all the data items shown in Table 1 and may include only some of the data items.

TABLE 1

| | Data type | Sensor/Meter | Data name |
|---|---|---|---|
| First-learning | Operation command data | | Command cutting speed |
| input data | | | Command position |
| | | | Command rotation speed for grinding |
| | | | wheel |
| | | | Command rotation speed for |
| | | | workpiece |
| | | | Coolant supply information |
| | Actual operation data | Current sensor | Motor drive current |
| | | Position sensor | Motor actual position |
| | First measurement data | Vibration sensor | Structural member vibration |
| | (structural member condition data) | Strain-gauge sensor | Structural member deformation |
| | Second measurement data | Sizing device | Workpiece size |
| | (ground portion data) | Temperature sensor | Grinding point temperature |
| First-learning | Grinding wheel surface condition | Damaged layer detector | First surface condition data |
| supervised data | data | | (corresponding to damaged layer) |
| | | Surface texture meter | Second surface condition data |
| | | | (corresponding to surface texture) |
| | | Chatter detector | Third surface condition data |
| | | | (corresponding to chatter pattern) |

The first input data obtaining unit 130 includes an operation-related data obtaining unit 110 and a measurement data obtaining unit 120. The operation-related data obtaining unit 110 includes the following: an operation command data obtaining unit 111 for obtaining the operation command data to be input to the controller 20; and an actual operation data obtaining unit 112 for obtaining, from the sensor 21, actual operation data on actual operation of the driving devices 12a, 14a, 15a, 16a, 17, and 18 that are controlled by the controller 20.

As shown in Table 1, the operation command data of operation-related data includes the following: a command cutting speed for each stage of grinding; a command position for each of the movable members 14 and 15 at transition between the stages; a command rotation speed for the grinding wheel 16; a command rotation speed for the workpiece W; and information about supply of coolant. The process of grinding the workpiece W has multiple stages, for example, including rough grinding, precision grinding, fine grinding, and spark-out. As shown in Table 1, the actual operation data of the operation-related data includes the following: drive currents through the driving devices such as the motor 12a; and actual positions of the driving devices such as the motor 12a. The actual operation data obtaining unit 112 obtains the actual operation data for a predetermined period of time for each workpiece W. For example, the predetermined period may be from the start to the end of the process of grinding the workpiece W or from the start to the end of one stage of the grinding process, such as the rough grinding stage. Before the grinding operation reaches a steady state, the actual operation data may be unstable. Therefore, the actual operation data may be obtained only after the grinding condition reaches a steady state.

The measurement data obtaining unit 120 includes the following: a first-measurement data obtaining unit 121 for obtaining the first measurement data from the sensor 22; and a second-measurement data obtaining unit 122 for obtaining the second measurement data from the sensor 23. The first measurement data is data measured during grinding of the workpiece W with the grinding wheel 16. For example, the first measurement data includes vibrations of the structural members 12, 13, 14, and 15 and the amount of deformation of the structural members 12, 13, 14, and 15. The second measurement data is data measured during grinding of the workpiece W with the grinding wheel 16. For example, the second measurement data includes the size (e.g., the diameter) of the workpiece W and a temperature at the point of contact between the grinding wheel 16 and the workpiece W.

The first-measurement data obtaining unit 121 obtains the first measurement data for a predetermined period of time for each workpiece W. The second-measurement data obtaining unit 122 obtains the second measurement data for a predetermined period of time for each workpiece W. Specifically, each of the first measurement data and the second measurement data is obtained for the same period of time as the actual operation data. As already described, for example, the predetermined period may be from the start to the end of the grinding process or from the start to the end of one stage of the grinding process, such as the rough grinding stage.

The surface condition data obtaining unit 140 obtains, as the first-learning supervised data for the supervised learning, the surface condition data of the grinding wheel 16 corresponding to the data on the quality of the ground workpiece W obtained by the external device 2. The surface condition data of the grinding wheel 16 includes the following: the first surface condition data corresponding to the condition of the damaged layer of the workpiece W (e.g., the degree of grinding burn, formation of a softened layer due to grinding, etc.); the second surface condition data corresponding to the surface texture (e.g., the surface roughness) of the workpiece W; and the third surface condition data corresponding to the condition of the chatter pattern on the workpiece W.

The first surface condition data may be the damaged layer data itself (e.g., data about the degree of grinding burn, data about a softened layer caused by grinding, etc.). Alternatively, the first surface condition data may be calculated on the basis of the damaged layer data. The second surface condition data may be the surface texture data itself relating to the workpiece W (e.g., data about surface roughness). Alternatively, the second surface condition data may be calculated on the basis of the surface texture data. The third surface condition data may be the chatter pattern data itself. Alternatively, the third surface condition data may be calculated on the basis of the chatter pattern data.

The first learning model creating unit 150 creates the first learning model by performing the supervised learning. Specifically, the first learning model creating unit 150 creates the first learning model for estimating the surface condition of the grinding wheel 16, by performing the machine learning using that uses, as the first-learning input data, the first input data relating to multiple workpieces W obtained by the first input data obtaining unit 130 and that uses, as the first-learning supervised data, the surface condition data of the grinding wheel 16 for each workpiece W obtained by the surface condition data obtaining unit 140.

That is, the first learning model creating unit 150 creates the first learning model by the machine learning that uses the operation command data, the actual operation data, the first measurement data, and the second measurement data, as the first-learning input data, and that uses the surface condition data of the grinding wheel 16 as the first-learning supervised data. The first learning model describes the relationship between the first-learning input data and the first-learning supervised data.

Out of all the first-learning input data, at least the actual operation data, the first measurement data, and the second measurement data are obtained for a predetermined period of time for each workpiece W. As a result, the amount of the first-learning input data relating to one workpiece W becomes large. Therefore, the amount of the first-learning input data relating to multiple workpieces W becomes extremely large. However, the use of machine learning makes it easy to create the first learning model using the extremely large amount of the first-learning input data relating to multiple workpieces W. In this way, the first learning model is created by taking into account the extremely large amount of the first-learning input data that influences the surface condition of the grinding wheel 16. This enables the first learning model to estimate the surface condition of the grinding wheel 16, as described later.

The first learning model is used to estimate the degree of influence on the quality of the ground workpiece W as the surface condition of the grinding wheel 16. For example, the first learning model is used to estimate the following conditions as the surface condition of the grinding wheel 16: glazing, loading, or shedding occurs on the surface of the grinding wheel 16; and the surface of the grinding wheel 16 is excessively sharpened.

For example, the first learning model is used to estimate the following conditions as the surface condition of the grinding wheel 16: a first surface condition corresponding to the condition of a damaged layer of the workpiece W; a second surface condition corresponding to surface texture of the workpiece W; and a third surface condition corresponding to the condition of a chatter pattern on the workpiece W. The first learning model may be used to estimate either all or one or two of the first, second and third surface conditions. The first learning model created by the first learning model creating unit 150 is stored in the first learning model storage 160.

For example, when the predetermined period for which the data used to create the first learning model is obtained is from the start to the end of the grinding process, the first learning model takes into account all the stages of the grinding process. As another example, when the predetermined period for which the data used to create the first learning model is obtained is from the start to the end of the rough grinding stage, the first learning model takes into account only the rough grinding stage. If it is necessary to identify which stage influences the quality of the ground workpiece W, the first learning model may be created for each stage.

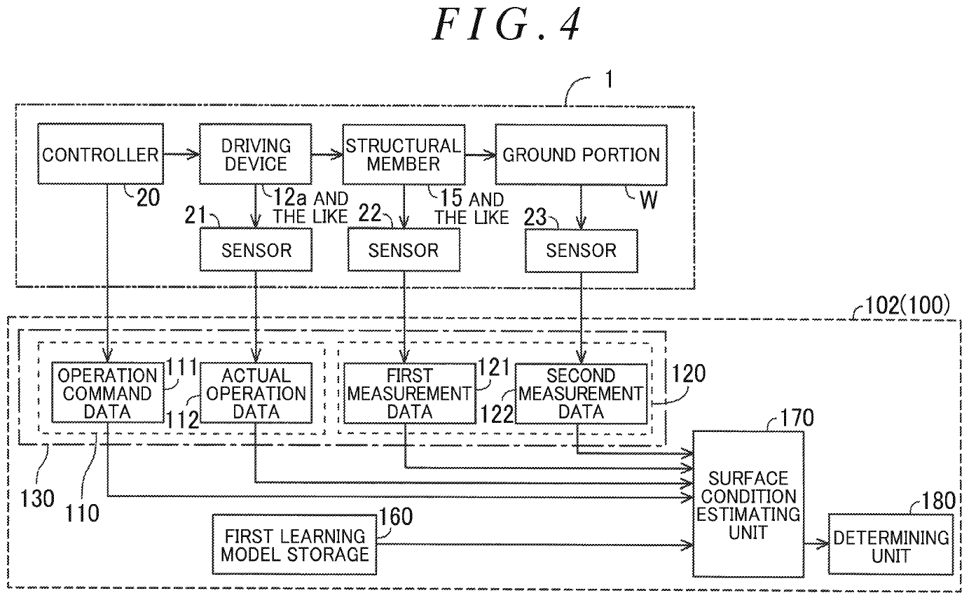

The detailed structure of the estimation phase 102 of the machine learning device 100 is described with reference to FIG. 4. The structure of the first learning phase 101 and the structure of the estimation phase 102 correspond to a grinding wheel surface condition estimating device. The structure of the first learning phase 101 is already described and therefore is not described here.

The structure of the estimation phase 102 includes the following: the first input data obtaining unit 130 for obtaining the first input data; the first learning model storage 160; a surface condition estimating unit 170; and a determining unit 180. The first input data obtaining unit 130 obtains first input data for a predetermined period of time during grinding of a new workpiece W, in the same manner as described above for the first learning phase 101. The predetermined period in the estimation phase 102 is the same as the predetermined period in the first learning phase 101. As described above, the first learning model storage 160 stores the first learning model that has been created by the first learning model creating unit 150 in the first learning phase 101.

The surface condition estimating unit 170 estimates the surface condition of the grinding wheel 16 after the new workpiece W is ground, by using the first learning model stored in the first learning model storage 160 and using, as estimation input data, the first input data obtained for the predetermined period of time during grinding of the new workpiece W. As already described, the first learning model describes the relationship between the first-learning input data and the first-learning supervised data.

Thus, the surface condition estimating unit 170 estimates the degree of influence on the quality of the ground workpiece W as the surface condition of the grinding wheel 16. For example, the surface condition estimating unit 170 estimates the following conditions as the surface condition of the grinding wheel 16: the first surface condition corresponding to the condition of the damaged layer of the workpiece W; the second surface condition corresponding to the surface texture of the workpiece W; and the third surface condition corresponding to the condition of the chatter pattern on the workpiece W. The surface condition estimating unit 170 may estimate either all or one or two of the first, second and third surface conditions. For example, the surface condition estimating unit 170 may estimate only the first surface condition. In this case, the first learning model is created as a model that estimates only the first surface condition.

As described above, the surface condition estimating unit 170 estimates multiple conditions as the surface condition. The use of the first learning model created by the machine learning allows the surface condition estimating unit 170 to estimate multiple conditions easily. Thus, the machine learning device 100 estimates complicated conditions at once.

The determining unit 180 determines, on the basis of the surface condition of the grinding wheel 16 estimated by the surface condition estimating unit 170, whether to perform at least one of the following processes: truing of the grinding wheel 16; dressing of the grinding wheel 16; and replacement of the grinding wheel 16. For example, when determining that the workpiece W has a damaged layer (i.e., a predetermined requirement is not satisfied) on the basis of the estimated first surface condition corresponding to the condition of the damaged layer, the determining unit 180 determines that dressing of the grinding wheel 16 needs to be performed. As another example, when determining that the estimated second surface condition corresponding to the surface texture fails to satisfy a predetermined requirement, the determining unit 180 determines that truing of the grinding wheel 16 needs to be performed. As still another example, when determining that the workpiece W has a chatter pattern (i.e., a predetermined requirement is not satisfied) on the basis of the estimated third surface condition corresponding to the condition of the chatter pattern, the determining unit 180 determines that dressing of the grinding wheel 16 needs to be performed.

In contrast, when the estimated first, second, and third surface conditions satisfy their respective requirements, the determining unit 180 determines that the grinding wheel 16 is in good condition for grinding. In this case, the determining unit 180 determines that neither dressing nor truing of the grinding wheel 16 needs to be performed. In this way, the use of the first learning model created by the machine learning makes it easy to determine whether multiple requirements are satisfied.

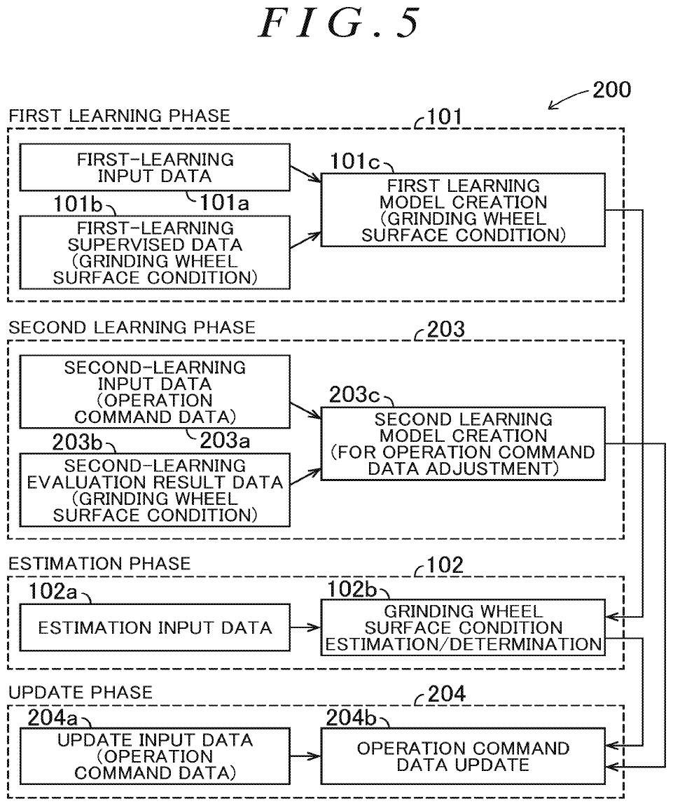

A machine learning device 200 according to a second embodiment is described with reference to FIG. 5. The machine learning device 200, as with the machine learning device 100 according to the first embodiment, performs the following: (a) creates a first learning model for estimating the surface condition of the grinding wheel 16; and (b) estimates the surface condition of the grinding wheel 16 using the first learning model. Further, in order to improve the quality of a workpiece W that is ground with the grinding wheel 16 and to reduce the number of times the grinding wheel 16 is corrected or replaced, the machine learning device 200 performs the following: (c) creates a second learning model used for adjusting operation command data for the grinding machine 1; and (d) updates the operation command data for the grinding machine 1 using the second learning model.

The machine learning device 200 includes the following elements: elements 101a, 101b, and 101c that function in a first learning phase 101 that creates the first learning model; and elements 102a and 102b that function in an estimation phase 102 that estimates the surface condition of the grinding wheel 16. The first learning phase 101 and the estimation phase 102 of the machine learning device 200 respectively have the same structure as the first learning phase 101 and the estimation phase 102 of the machine learning device 100 described in the first embodiment.

Further, the machine learning device 200 includes the following elements that function in a second learning phase 203 that creates the second learning model: an element 203a that obtains second-learning input data; an element 203b that obtains second-learning evaluation result data; and an element 203c that creates the second learning model.

The second-learning input data obtained by the element 203a is used for machine learning. For example, the operation command data is used as the second-learning input data. As shown in Table 1 described in the first embodiment, the operation command data includes the following: a command cutting speed for each stage of grinding; a command position for each of the movable members 14 and 15 at transition between the stages; a command rotation speed for the grinding wheel 16; a command rotation speed for the workpiece W; and information about supply of coolant. The operation command data is used to create an NC program to be executed by the controller 20.

The second-learning evaluation result data obtained by the element 203b is used to derive a reward for reinforcement learning in the machine learning. The surface condition data of the grinding wheel 16 is used as the second-learning evaluation result data. The element 203c creates the second learning model by performing the reinforcement learning in the machine learning on the basis of the second-learning input data and the second-learning evaluation result data. The second learning model is a model (a function) used to adjust the operation command data for the grinding machine 1.

The machine learning device 200 further includes the following elements that function in an update phase 204 that updates the operation command data: an element 204a that obtains update input data; and an element 204b that updates the operation command data. The update input data obtained by the element 204a has the same type of data as the second-learning input data and is obtained in connection with grinding of a workpiece W (a new workpiece W) other than the workpieces W used to create the second learning model. The element 204b updates the operation command data using the update input data, the second learning model, and an estimated surface condition of the grinding wheel 16. The second learning model to be used by the element 204b is the second learning model created by machine learning in the second learning phase 203. The estimated surface condition of the grinding wheel 16 to be used by the element 204b is the surface condition of the grinding wheel 16 estimated in the estimation phase 102.

The detailed structure of the first learning phase 101 of the machine learning device 200 is the same as that of the machine learning device 100 described in the first embodiment.

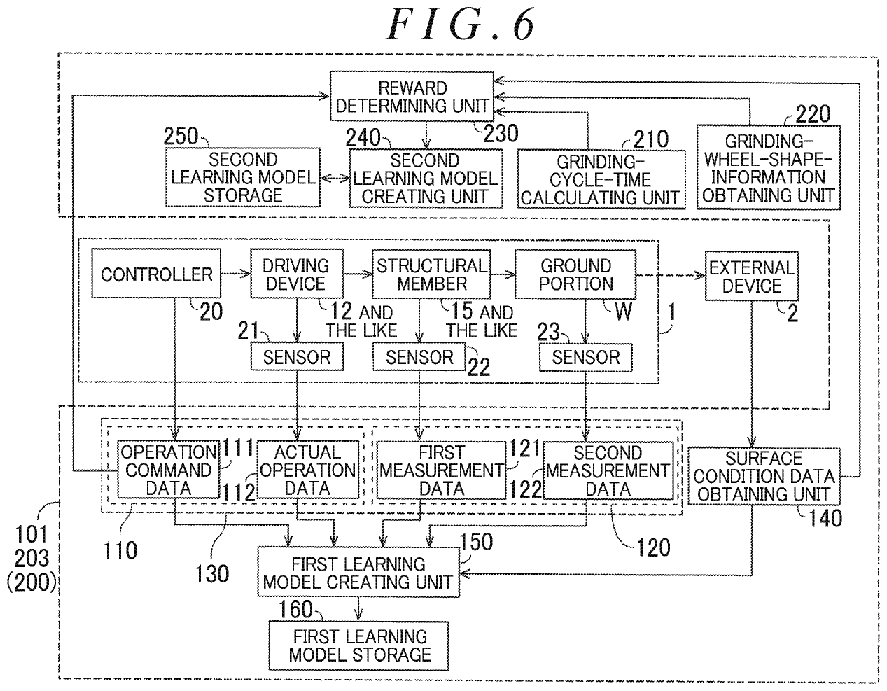

The detailed structure of the second learning phase 203 of the machine learning device 200 is described with reference to FIG. 6. The structure of the second learning phase 203 corresponds to an adjustment model creating device for grinding machine operation command data adjustment.

The structure of the second learning phase 203 includes the following: an operation command data obtaining unit 111; a surface condition data obtaining unit 140; a grinding-cycle-time calculating unit 210; and a grinding-wheel-shape-information obtaining unit 220; a reward determining unit 230; a second learning model creating unit 240; and a second learning model storage 250.

When workpieces W are ground with the grinding wheel 16 in the grinding machine 1, the operation command data obtaining unit 111 obtains the operation command data to be input to the controller 20 of the grinding machine 1. The operation command data obtaining unit 111 obtains, as the second-learning input data for the machine learning, the operation command data relating to the multiple workpieces W. Each time grinding of one of the workpieces W is finished, the surface condition data obtaining unit 140 obtains, as the second-learning evaluation result data for the machine learning, the surface condition data of the grinding wheel 16 relating to the ground workpiece W. Examples of the second-learning input data and the second-learning evaluation result data are shown in Table 2. Although Table 2 shows that the second-learning input data includes various data items, the second-learning input data does not necessarily include all the data items shown in Table 2 and may include only some of the data items.

TABLE 2

| | Data type | Sensor/Meter | Data name |
|---|---|---|---|
| [symbol] arnin [symbol] | Operation command data | | Command cutting speed |
| | | | Command position |
| | | | Command rotation speed for grinding |
| | | | wheel |
| | | | Command rotation speed for |
| | | | workpiece |
| | | | Coolant supply information |
| Second-learning | Grinding wheel surface condition | Damaged layer detector | First surface condition data |
| evaluation result data | data | | (corresponding to damaged layer) |
| | | Surface texture meter | Second surface condition data |
| | | | (corresponding to surface texture) |
| | | Chatter detector | Third surface condition data |
| | | | (corresponding to chatter pattern) |

[symbol]

indicates data missing or illegible when filed

The grinding-cycle-time calculating unit 210 calculates a grinding cycle time per workpiece W. Specifically, the grinding cycle time is calculated by dividing the sum of the following times by the number of the workpieces W: the time taken to grind all the workpieces W; the time taken to replace the grinding wheel 16 during grinding of all the workpieces W; the time taken to perform dressing of the grinding wheel 16 during grinding of all the workpieces W; and the time taken to perform truing of the grinding wheel 16 during grinding of all the workpieces W. That is, the grinding cycle time decreases as the number of times the grinding wheel 16 is replaced decreases, as the number of times dressing of the grinding wheel 16 is performed decreases, and as the number of times truing of the grinding wheel 16 is performed decreases.

The grinding-wheel-shape-information obtaining unit 220 obtains shape information about the shape of the grinding wheel 16. Specifically, the grinding-wheel-shape-information obtaining unit 220 obtains, as the shape information, the size (e.g., the diameter) of the grinding wheel 16 measured by the grinding wheel correction device 18. That is, the grinding-wheel-shape-information obtaining unit 220 obtains the shape information when the grinding wheel correction device 18 performs truing or dressing of the grinding wheel 16. The grinding-wheel-shape-information obtaining unit 220 may further obtain, as the shape information, a change in the size of the grinding wheel 16 and deformation of the grinding wheel 16.

The reward determining unit 230 obtains the operation command data as the second-learning input data, obtains the surface condition data of the grinding wheel 16 as the second-learning evaluation result data, and determines a reward for the operation command data in accordance with the surface condition data. In the reinforcement learning, the reward is given for a combination of data items of the operation command data. When the surface condition data corresponding to the operation command data indicates a desirable result, a large reward is given for the operation command data. In contrast, when the surface condition data corresponding to the operation command data indicates an undesirable result, a small reward (including a negative reward) is given for the operation command data.

For example, the reward determining unit 230 increases the reward when the ground workpiece W does not have a damaged layer corresponding to the first surface condition data, and reduces the reward when the ground workpiece W has the damaged layer. As another example, the reward determining unit 230 increases the reward when surface texture of the ground workpiece W corresponding to the second surface condition data is less than or equal to a predetermined threshold, and reduces the reward when the surface texture is greater than the predetermined threshold. As still another example, the reward determining unit 230 increases the reward when the ground workpiece W does not have a chatter pattern corresponding to the third surface condition data, and reduces the reward when the ground workpiece W has the chatter pattern. The reward determining unit 230 determines the reward on the basis of either all or one or two of the first surface condition data, the second surface condition data, and the third surface condition data.

Further, the reward determining unit 230 obtains the grinding cycle time calculated by the grinding-cycle-time calculating unit 210 and determines the reward for the operation command data in accordance with the grinding cycle time. Specifically, the reward determining unit 230 increases the reward as the grinding cycle time decreases. That is, the reward determining unit 230 increases the reward as at least one of the following times decreases: the time taken to replace the grinding wheel 16; the time taken to perform dressing of the grinding wheel 16; and the time taken to perform truing of the grinding wheel 16.

In addition, the reward determining unit 230 determines the reward on the basis of the shape information about the grinding wheel 16 obtained by the grinding-wheel-shape-information obtaining unit 220. Specifically, the reward determining unit 230 increases the reward as the change in the size of the grinding wheel 16 decreases and as the deformation of the grinding wheel 16 decreases.

The second learning model creating unit 240 performs the machine learning to create the second learning model that adjusts the operation command data in such a manner as to increase the reward. The second learning model creating unit 240 uses, as the reinforcement learning, a Q-learning method, a Sarsa method, a Monte Carlo method, etc.

It is assumed here that the operation command data before adjustment relates to a first workpiece W and that the operation command data after adjustment relates to a second workpiece W. Further, a relationship between the operation command data relating to the first workpiece W and the surface condition data of the grinding wheel 16 after the first workpiece W is ground is defined as a first data relationship. Likewise, a relationship between the operation command data relating to the second workpiece W and the surface condition data of the grinding wheel 16 after the second workpiece W is ground is defined as a second data relationship.

The second learning model describes the correlation between the first data relationship before adjustment and the second data relationship after adjustment. The second learning model creating unit 240 learns an adjustment method for adjusting the operation command data for the first workpiece W to the operation command data for the second workpiece W in such a manner that the reward is increased, specifically, in such a manner that the surface condition data of the grinding wheel 16 after the second workpiece W is ground becomes better than the surface condition data of the grinding wheel 16 after the first workpiece W is ground.

It is noted that the amount of adjustment of the operation command data is limited such that a change in the operation command data before and after adjustment falls within a predetermined range. For example, regarding the command cutting speed as one of adjustable parameters in the operation command data, a change in the command cutting speed after adjustment is limited to a predetermined percentage (e.g., plus/minus three percent) of the command cutting speed before adjustment. The predetermined percentage can be any suitable value. The same applies to other adjustable parameters, such as the command position, the command rotation speed for the grinding wheel 16, the command rotation speed for the workpiece W, and the information about supply of coolant. Some of the parameters may be set to be adjustable. The second learning model created by the second learning model creating unit 240 is stored in the second learning model storage 250.

The second learning model creating unit 240 may learn the second learning model not only in the second learning phase 203 but also in the update phase 204 that is described later. In this case, the surface condition data of the grinding wheel 16 obtained in the estimation phase 102 (refer to the first embodiment) is used as the second-learning evaluation result data.

The detailed structure of the estimation phase 102 of the machine learning device 200 is the same as that of the machine learning device 100 described in the first embodiment.

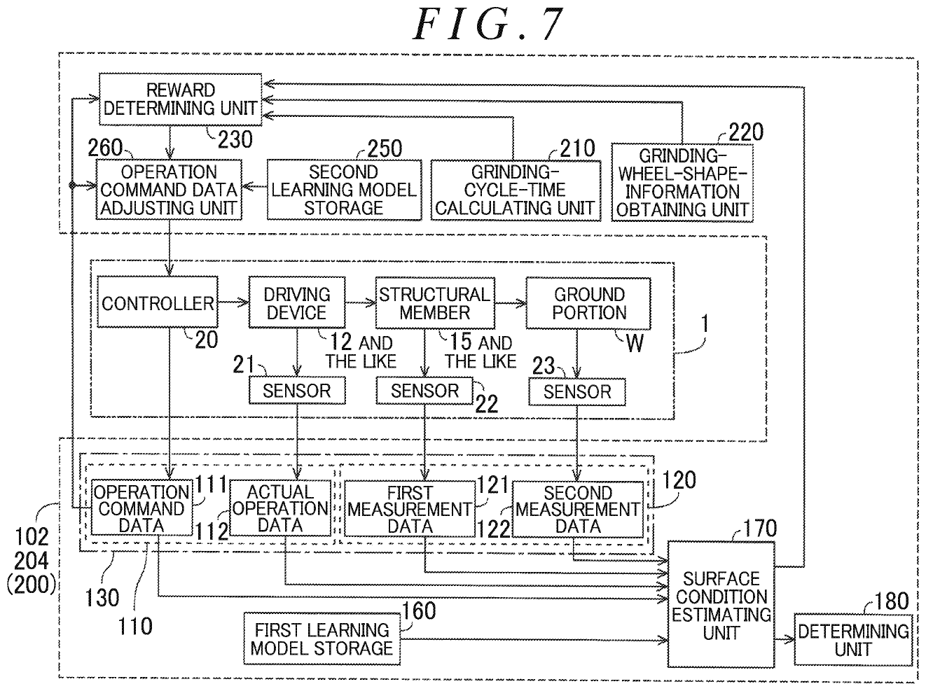

The detailed structure of the update phase 204 of the machine learning device 200 is described with reference to FIG. 7. The structure of the second learning phase 203 and the structure of the update phase 204 correspond to an updating device for grinding machine operation command data update. The structure of the second learning phase 203 is already described and therefore is not described here.

The structure of the update phase 204 includes the following: the operation command data obtaining unit 111; the surface condition data obtaining unit 140; the grinding-cycle-time calculating unit 210; and the grinding-wheel-shape-information obtaining unit 220; the reward determining unit 230; the second learning model storage 250; and an operation command data adjusting unit 260.

The operation command data obtaining unit 111 and the surface condition data obtaining unit 140 respectively obtain the operation command data and the surface condition data in connection with grinding of a new workpiece W, substantially in the same manner as described above for the second learning phase 203. The grinding-cycle-time calculating unit 210 and the grinding-wheel-shape-information obtaining unit 220 also operate substantially in the same manner as described above for the second learning phase 203.

The reward determining unit 230 determines the reward using the operation command data and the surface condition data of the grinding wheel 16 that are obtained in connection with grinding of the new workpiece W. That is, the reward determining unit 230 determines the reward for the operation command data used to grind the new workpiece W in accordance with the surface condition data after the new workpiece W is ground. As described above regarding the second learning phase 203, the second learning model storage 250 stores the second learning model that has been created by the second learning model creating unit 240.

The operation command data adjusting unit 260 determines the adjustment method for adjusting the operation command data, by using the following: the operation command data used to grind the new workpiece W; the surface condition data of the grinding wheel 16 after the new workpiece W is ground; the reward; and the second learning model. Then, the operation command data adjusting unit 260 adjusts the operation command data on the basis of the determined adjustment method. As described above, the second learning model is created by learning the method that adjusts the operation command data before adjustment to the operation command data after adjustment in such a manner that the reward is increased.

Specifically, the operation command data adjusting unit 260 obtains the present operation command data (i.e., the operation command data used to grind the new workpiece W) as the operation command data before adjustment and obtains the reward given for the present operation command data. In this case, the operation command data adjusting unit 260 determines next operation command data for a next workpiece W by using the following: the present operation command data; the reward given for the present operation command data; and the second learning model. Thus, the next operation command data is determined to receive a reward larger than the reward given for the present operation command data.

The operation command data adjusting unit 260 may produce multiple candidates for the next operation command data that receive the same reward. In this case, for example, the operation command data adjusting unit 260 may rank the candidates by assigning priorities to the adjustable parameters such as a command cutting speed and a command rotation speed for the workpiece W. For example, first priority may be assigned to the command cutting speed, and second priority may be assigned to the command rotation speed.

The operation command data adjusting unit 260 determines the first ranked candidate as the next operation command data and updates the present operation command data to the next operation command data. Thus, the grinding machine 1 performs grinding of the next workpiece W on the basis of the updated operation command data. Then, in the update phase 204 of the machine learning device 200, the next operation command data is adjusted to further next operation command data for a further next workpiece W, on the basis of the data in connection with grinding of the next workpiece W. The frequency of adjustment of the operation command data may be set. For example, the operation command data may be adjusted each time a predetermined number of workpieces W are ground.

In summary, according to the second embodiment, the operation command data is updated using the second learning model created by the machine learning in the machine learning device 200. Thus, when grinding conditions change, the operation command data is updated in accordance with the present grinding condition. The update of the operation command data allows grinding to be performed in accordance with the surface condition of the grinding wheel 16.

That is, the update of the operation command data makes the surface condition of the grinding wheel 16 better. This leads to improvement in the quality of the workpiece W that is ground with the grinding wheel 16. Further, the update of the operation command data reduces the time taken to replace the grinding wheel 16, the time taken to perform dressing of the grinding wheel 16, and the time taken to perform truing of the grinding wheel 16. As a result, the grinding cycle time is reduced. Furthermore, the update of the operation command data reduces a change in the size of the grinding wheel 16 and deformation of the grinding wheel 16.

1: An estimation model creating device for grinding wheel surface condition estimation comprising:
a measurement data obtaining unit configured to obtain a plurality of measurement data pieces measured during grinding of a plurality of workpieces with a grinding wheel in a grinding machine, each measurement data piece being obtained for a predetermined period of time during grinding of a corresponding one of the plurality of workpieces, each measurement data piece including at least one of first measurement data and second measurement data, the first measurement data indicating a condition of a structural member of the grinding machine, the second measurement data relating to a ground portion of the corresponding workpiece; and
a first learning model creating unit configured to perform machine learning using the plurality of measurement data pieces of the plurality of workpieces as first-learning input data so as to create a first learning model for estimating a surface condition of the grinding wheel.

2: The estimation model creating device for grinding wheel surface condition estimation according to claim 1, wherein
each measurement data piece includes both the first measurement data and the second measurement data,
the first measurement data includes at least one of vibration of the structural member of the grinding machine and an amount of deformation of the structural member of the grinding machine,
the second measurement data includes at least one of a size of the corresponding workpiece and a temperature at a point of contact between the grinding wheel and the corresponding workpiece, the size changing as the corresponding workpiece is ground, and
the machine learning performed by the first learning model creating unit uses the first measurement data and the second measurement data of the plurality of measurement data pieces of the plurality of workpieces as the first-learning input data so as to create the first learning model.

3: The estimation model creating device for grinding wheel surface condition estimation according to claim 1, further comprising:
a surface condition data obtaining unit configured to obtain a plurality of surface condition data pieces about the surface condition of the grinding wheel, each surface condition data piece being obtained in connection with grinding of a corresponding one of the plurality of workpieces, wherein
the machine learning performed by the first learning model creating unit uses the plurality of surface condition data pieces of the grinding wheel as supervised data so as to create the first learning model.

4: The estimation model creating device for grinding wheel surface condition estimation according to claim 3, wherein
each surface condition data piece of the grinding wheel indicates a degree of influence on a quality of the corresponding workpiece that is ground.

5: The estimation model creating device for grinding wheel surface condition estimation according to claim 4, wherein
each surface condition data piece of the grinding wheel includes at least one of first surface condition data, second surface condition data, and third surface condition data, as data indicating the degree of influence on the quality of the corresponding workpiece that is ground,
the first surface condition data corresponds to a condition of a damaged layer of the corresponding workpiece,
the second surface condition data corresponds to surface texture of the corresponding workpiece, and
the third surface condition data corresponds to a condition of a chatter pattern on the corresponding workpiece.

6: The estimation model creating device for grinding wheel surface condition estimation according to claim 1, further comprising:
an operation-related data obtaining unit configured to obtain a plurality of operation-related data pieces, each operation-related data piece being obtained for a predetermined period of time during grinding of a corresponding one of the plurality of workpieces, each operation-related data piece including at least one of operation command data for a controller of the grinding machine and actual operation data about actual operation of a driving device of the grinding machine controlled by the controller, wherein
the machine learning performed by the first learning model creating unit uses both the plurality of measurement data pieces of the plurality of workpieces and the plurality of operation-related data pieces as the first-learning input data so as to create the first learning model.

7: A grinding wheel surface condition estimating device comprising:
the estimation model creating device for grinding wheel surface condition estimation according to claim 1; and
a surface condition estimating unit configured to estimate the surface condition of the grinding wheel after a new workpiece is ground, by using the first learning model and estimation input data, the estimation input data having a same type of data as each measurement data piece and obtained for a predetermined period of time during grinding of the new workpiece.

8: The grinding wheel surface condition estimating device according to claim 7, wherein
the surface condition of the grinding wheel indicates a degree of influence on a quality of the new workpiece that is ground.

9: The grinding wheel surface condition estimating device according to claim 8, wherein
the first learning model creating unit creates the first learning model to estimate, as the surface condition of the grinding wheel, at least one of a first surface condition, a second surface condition, and a third surface condition,
the first surface condition corresponds to a condition of a workpiece damaged layer,
the second surface condition corresponds to a workpiece surface texture,
the third surface condition corresponds to a condition of a workpiece chatter pattern, and
the surface condition estimating unit estimates, as the surface condition of the grinding wheel after the new workpiece is ground, at least one of the first surface condition, the second surface condition, and the third surface condition.

10: The grinding wheel surface condition estimating device according to claim 7, further comprising:
a determining unit configured to determine, on a basis of the surface condition of the grinding wheel estimated by the surface condition estimating unit, whether to perform at least one of truing of the grinding wheel, dressing of the grinding wheel, and replacement of the grinding wheel.

11: An adjustment model creating device for grinding machine operation command data adjustment, the adjustment model creating device comprising:
an operation command data obtaining unit configured to obtain a plurality of operation command data pieces in connection with grinding of a plurality of workpieces with a grinding wheel in a grinding machine, each operation command data piece being used to control a controller of the grinding machine during grinding of a corresponding one of the plurality of workpieces;
a surface condition data obtaining unit configured to obtain a plurality of surface condition data pieces about a surface condition of the grinding wheel, each surface condition data piece being obtained in connection with grinding of a corresponding one of the plurality of workpieces;
a reward determining unit configured to determine a reward for each operation command data piece in accordance with a corresponding one of the plurality of surface condition data pieces, each surface condition data piece being obtained in connection with grinding of a corresponding one of the plurality of workpieces; and
a second learning model creating unit configured to perform machine learning using each operation command data piece and the reward of the plurality of workpieces to create a second learning model for adjusting each operation command data piece in such a manner as to increase the reward.

12: The adjustment model creating device for grinding machine operation command data adjustment according to claim 11, wherein
each surface condition data piece of the grinding wheel indicates a degree of influence on a quality of the corresponding workpiece that is ground.

13: The adjustment model creating device for grinding machine operation command data adjustment according to claim 12, wherein
each surface condition data piece of the grinding wheel includes at least one of first surface condition data, second surface condition data, and third surface condition data, as data indicating the degree of influence on the quality of the corresponding workpiece that is ground,
the first surface condition data corresponds to a condition of a damaged layer of the corresponding workpiece,
the second surface condition data corresponds to surface texture of the corresponding workpiece, and
the third surface condition data corresponds to a condition of a chatter pattern on the corresponding workpiece.

14: The adjustment model creating device for grinding machine operation command data adjustment according to claim 13, wherein
the reward determining unit increases the reward when the damaged layer corresponding to the first surface condition data does not exist and reduces the reward when the damaged layer exists.

15: The adjustment model creating device for grinding machine operation command data adjustment according to claim 13, wherein
the reward determining unit increases the reward when the surface texture of the workpiece corresponding to the second surface condition data is less than or equal to a predetermined threshold and reduces the reward when the surface texture is greater than the predetermined threshold.

16: The adjustment model creating device for grinding machine operation command data adjustment according to claim 13, wherein
the reward determining unit increases the reward when the chatter pattern corresponding to the third surface condition data does not exist and reduces the reward when the chatter pattern exists.

17: The adjustment model creating device for grinding machine operation command data adjustment according to claim 11, wherein
the reward determining unit increases the reward as a change in size of the grinding wheel decreases or as deformation of the grinding wheel decreases.

18: The adjustment model creating device for grinding machine operation command data adjustment according to claim 11, wherein
the reward determining unit increases the reward as at least one of a time taken to replace the grinding wheel, a time taken to perform dressing of the grinding wheel, and a time taken to perform truing of the grinding wheel decreases.

19: The adjustment model creating device for grinding machine operation command data adjustment according to claim 11, wherein
the surface condition of the grinding wheel is estimated by a grinding wheel surface condition estimating device and is used as each surface condition data piece of the grinding wheel, and
the grinding wheel surface condition estimating device comprises:
an estimation model creating device for grinding wheel surface condition estimation comprising:
a measurement data obtaining unit configured to obtain a plurality of measurement data pieces measured during grinding of the plurality of workpieces with the grinding wheel in the grinding machine, each measurement data piece being obtained for a predetermined period of time during grinding of a corresponding one of the plurality of workpieces, each measurement data piece including at least one of first measurement data and second measurement data, the first measurement data indicating a condition of a structural member of the grinding machine, the second measurement data relating to a ground portion of the corresponding workpiece, and
a first learning model creating unit configured to perform machine learning using the plurality of measurement data pieces of the plurality of workpieces as first-learning input data so as to create a first learning model for estimating the surface condition of the grinding wheel, and
a surface condition estimating unit configured to estimate the surface condition of the grinding wheel after a new workpiece is ground, by using the first learning model and estimation input data, the estimation input data having a same type of data as each measurement data piece and obtained for a predetermined period of time during grinding of the new workpiece.

20: An updating device for grinding machine operation command data update, the updating device comprising:
the adjustment model creating device for grinding machine operation command data adjustment according to claim 11; and
an operation command data adjusting unit configured to adjust the operation command data piece for a first new workpiece to be ground after a second new workpiece, by using the operation command data piece for the second new workpiece, the surface condition data piece relating to the second new workpiece, the reward, and the second learning model.
